(19) United States
(12) Patent Application Publication
(10) Pub. No.: US 2008/0149251 A1
(43) Pub. Date: Jun. 26, 2008

(54) Use of Cross-Linked Rubber Mass

(75) Inventors: Stefan Mundt, Monheim Am Rhein (DE); Peter Rambusch, Wuppertal (DE)

Correspondence Address: COLLARD & ROE, P.C., 1077 NORTHERN BOULEVARD, ROSLYN, NY, 11576, US

(73) Assignee: CERTOPLAST VORWERK & SOHN GMBH, Wuppertal (DE)

(21) Appl. No.: 11/659,767

(22) PCT Filed: Aug. 5, 2005
(86) PCT No.: PCT/EP05/08523

§ 371 Date: Feb. 8, 2007

(30) Foreign Application Priority Data
Aug. 9, 2004 (DE) 10 2004 038 776.1

(51) Int. Cl. H01B 13/00

(52) U.S. Cl. 156/47

(57) ABSTRACT

The invention relates to the use of cross-linked rubber masses as a one-sided or double-sided adhesive coating on a strip-type carrier, for the production of a self-adhesive strip for grouping cables in motor vehicles. According to the invention, a cross-linking agent is added to the rubber mass as a photoinitiator.

The invention relates to the use of cross-linked rubber mass as a one-sided or two-sided adhesive coating on a strip-shaped support in the course of the production of a self-adhesive strip for bundling cables in motor vehicles.

In usual parlance, a self-adhesive strip refers to an adhesive strip that is equipped with an adhesive coating on one or both sides. Such an adhesive is characterized by a permanently sticky film layer. This permanently sticky film layer forms after evaporation of a liquid phase of a solution or dispersion, or after cooling of a melt. In the first case mentioned, the adhesive, i.e. the adhesive mass is applied to the strip-shaped support as a solution or dispersion, respectively, and leaves the film described, after evaporation of the solvent. The same holds true for the case that the adhesive, i.e. the adhesive mass, is heated for application to the strip-shaped support, in order to reduce its viscosity, and then forms the sticky film after cooling.

A self-adhesive strip is described in EP 0 937 761 B1, which is suitable for sheathing cables in automobiles. Here, an adhesive mass on the basis of acrylic hot melt is used, which can be cross-linked by means of radiation chemistry.

In addition, it has become known by means of U.S. Pat. No. 5,681,654 to apply a rubber mass onto a strip-shaped support, as an adhesive coating, in the course of the production of a self-adhesive strip. It remains open whether and how cross-linking is carried out, in detail.

Adhesive masses on the basis of acrylate hot melt are preferably used for the production of self-adhesive strips for sheathing cables in automobiles, i.e. motor vehicles, because they have good aging resistance and temperature stability. Temperatures of up to 125° C. and more can easily occur in the automotive applications described, and these cannot be mastered by adhesive masses on a rubber basis without significant technical and economic expenditure. This is attributable to the fact that rubbers demonstrate viscous flow behavior at higher temperatures and/or under the influence of deforming forces. On the other hand, rubber masses are convincing because of the possibility of cost-advantageous production.

At the same time, rubber-based adhesive masses develop a high immediate adhesion, as compared with acrylic-based adhesives, and are convincing because of their maximal adhesion forces. As a result, reliable processing particularly in the area of use of cable set bundling in motor vehicles is predestined.

The prior art according to DE 198 46 901 A1, which essentially forms the type of the state of the art, deals with a method for the production of adhesive strips, whereby adhesive strips coated with an adhesive mass on one side are subjected to cross-linking by means of radiation chemistry. Adhesive masses that are mentioned are, among others, natural rubber systems. In total, the irradiation of the adhesive strip is supposed to take place through the support material of the adhesive strip, onto the adhesive mass, in such a manner that the support material and the adhesive mass that faces the support material receive a dose of 30 to 200 kGy. The known method of procedure utilizes so-called electron beam cross-linking. In this connection, no chemical cross-linking agents are added. Because of the high-energy electron radiation, this cross-linking method sets special requirements with regard to work protection, and is consequently quite cost-intensive, as far as the systems, etc. that are required are concerned.

In total, what is supposed to be achieved by means of the high radiation dose described in DE 198 46 901 A1 is intensive cross-linking of the adhesive mass layer on the side facing the support, and what is supposed to be prevented is that adhesive mass components can migrate onto the open support side. Because of the cost-intensive electron beam source and in view of the enormous cost pressure in the production of such self-adhesive strips, such electron beam sources are unsuitable for use in the automotive industry, for practical purposes.

The invention is based on the technical problem of indicating a self-adhesive strip that can be produced in cost-advantageous manner and is particularly suitable for the purpose of use in automobile production.

To solve this technical problem, the object of the invention is the use of cross-linked rubber mass as a one-sided or two-sided adhesive coating on a strip-shaped support in the course of the production of a self-adhesive strip for bundling cables in motor vehicles, whereby a cross-linking agent is added to the rubber mass as a photoinitiator.

The term rubber, i.e. rubber mass used according to the invention refers to polymers having rubber-elastic properties at room temperatures, which are as usual not cross-linked, but can be cross-linked. Within the scope of the invention, a specially cross-linked rubber mass, i.e. rubber adhesive mass is now used on the strip-shaped support, as an adhesive coating.

In this connection, it is advantageous to use a thermoplastic rubber on the basis of a styrene block copolymer as the rubber mass. Adhesive masses on a rubber basis, whose formulation is based on a styrene block copolymer such as that distributed by the Shell company under the trade name Kraton D-KX 222C should be mentioned as being very particularly preferred.

By means of combining the block copolymer described, i.e. the rubber mass in general, with resins, tackifiers that make the mass sticky, and one or more system-suitable photoinitiators, an adhesive appropriate for the use can be produced, which can be cross-linked by means of radiation, in advantageous manner, specifically with UV rays.

The thermoplastic rubber mass used according to the invention, preferably on the basis of the styrene block copolymer, can be variably adjusted in terms of its adhesion properties, depending on the photoinitiator used and as a function of the concentration of the latter in the rubber mass in question, in order to support the radiation cross-linking. After all, depending on the degree of cross-linking, an improvement in the adhesion properties can be achieved in the case of such rubbers. Usually, the photoinitiator added to the rubber mass as a cross-linking agent assures that a plurality of photochemical transformations occurs in the rubber mass (under irradiation with UV light). Thus, the photoinitiator can form reactive fragments of free radicals, for example, which promote the cross-linking of the rubber mass, i.e. its polymerization. In this connection, a greater concentration of the photoinitiator(s) naturally increases the cross-linking density in the rubber mass.

It has generally proven itself if the photoinitiator or the several photoinitiators in the rubber mass are present at more than one wt.-%, whereby a preferred composition contains 2 to 20 wt.-% of the photoinitiator, with reference to the rubber mass. A composition in which 2 to 15 wt.-%, particularly 2 to 7 wt.-% of the photoinitiator are present in the rubber mass is very particularly preferred.

Suitable photoinitiators are those on the basis of benzophenones as well as an amine, if applicable, i.e. those that are described as examples in DE 699 16 245 T2 (cf. paragraph [0024] there). —At this point, photoinitiators from the Ciba company, which are distributed under the trade name IRGACURE, have proven themselves to be particularly advantageous. These are highly reactive benzyl dimethyl ketals.

Furthermore, it is recommended to work with photoinitiators that do not react to sunlight and not to the spectrum of fluorescent lamps. This is because uncontrolled subsequent cross-linking can occur due to both radiation sources. Therefore, it is advantageous to use photoinitiators that are sensitive at wavelengths ≦400 nm. This is because UV lamp sources are primarily used for cross-linking, and here, so-called mercury radiators are mainly used, which emit radiation in the wavelength range of 250 nm to 400 nm, which is important for the cross-linking reaction, with particular intensity.

When this UV light impacts the rubber mass to be cross-linked, with the photoinitiator that has been introduced into it, the photoinitiators already discussed above are split up by means of the UV light, and then start the polymerization and, as a consequence of this, the desired cross-linking, which raises the plastification point and melting point of the rubber mass. For this reason, one also speaks of cross-linking the rubber mass by means of radiation chemistry. —The thermoplastic rubber mass used according to the invention, for example on the basis of the styrene block copolymer, can always be variably adjusted in terms of its adhesion properties, depending on the photoinitiator used and its weight proportion in the rubber mass, to support radiation cross-linking.

This is only possible to a slight extent in the case of cross-linking acrylate adhesives. This is because influencing the degree of cross-linking is accompanied by an increased molecular weight and only succeeds to a slight degree. In fact, the photoinitiator mentioned is chemically bound in the polymer in the case of such acrylate melt adhesives, and therefore cannot be varied by type and concentration, and consequently adapted to the application case in question. As a result, the adhesion properties are more or less fixed (cf. EP 0 937 761 B1).

In contrast, the cross-linked, i.e. radiation cross-linked rubber adhesive mass used according to the invention can be adjusted in a wide range, with regard to its degree of cross-linking, by means of the use of variable and consequently different photoinitiators, with regard to the adhesion properties, and therefore can be optimally adapted to the substrate to be processed (the cables to be bundled). This is particularly true in view of the background that the addition to photoinitiators can be varied within the framework of the indicated weight proportions, in terms of weight, in comparison with the rubber adhesive mass, and that a cross-linking density that is also variable corresponds to this. In addition, there is a high immediate adhesion according to the invention, and consequently a greater working reliability, which cannot be provided by the acrylate adhesives according to the state of the art, according to EP 0 937 761 B1.

For processing of the claimed rubber mass, i.e. rubber adhesive mass, the latter can be applied to the strip-shaped support as a so-called hot melt, i.e. adhesive melt, in the low-viscosity state. Subsequently, cross-linking of the rubber mass according to radiation chemistry, by means of ultraviolet irradiation, takes place. Processing of the rubber mass as a polymer dispersion from an aqueous or solvent phase, with subsequent drying process and after that, cross-linking, i.e. radiation cross-linking, is possible just as well, and is covered.

By means of the use of the cross-linked, i.e. radiation cross-linked rubber mass in place of the acrylate-based adhesive in EP 0 937 761 B1, a clear cost advantage is already achieved, because the rubber masses in question are available in large amounts and at low prices. At the same time, the temperature stability is increased by means of radiation cross-linking of the rubber mass. Here, the invention recommends cross-linking the rubber mass using the general electromagnetic radiation already mentioned, particularly UV radiation. This can be carried out supplementally, in the course of the radiation chemistry process described.

It has proven to be advantageous if the rubber mass is applied to the support in the low-viscosity state, as a hot melt, i.e. a polymer melt, and subsequently subjected to (radiation chemistry) cross-linking. After all, in this way it is possible to do without additional solvents and to simplify handling overall. The absence of a related dilution/transport medium therefore results in particular economic and ecological advantages, although application as a dispersion is fundamentally also possible and is covered, as was already described.

In all cases, the radiation cross-linking described leads to chemical cross-linking in the molecular structure of the polymer used, and therefore to an increase in molecular weight. This is accompanied by a great increase in cohesion of the adhesive, even at temperatures above 125° C., actually even at temperatures above 160° C. Consequently, the increased adhesion capacity at these temperatures can be explained as the result of the increased cross-linking.

Furthermore, the cross-linked rubber mass used according to the invention essentially no longer possesses a plastification point, because of the cross-linking procedure described. The viscous flow behavior at higher temperatures, which was described initially and is possibly disadvantageous for uses in the automotive sector, is therefore no longer present, so that the use of the rubber mass in question for the purpose indicated can be explained. Furthermore, the radiation chemistry cross-linking results in significantly better stability of the rubber adhesive mass with regard to aggressive media such as engine oil, gasoline, and the like, so that in this way, it is once again particularly suitable for the claimed use.

In addition, it has turned out that soft PVC vehicle cable sheathings or general sheathings with a high content of monomer plasticizers (e.g. DOP) can be used in the motor vehicle sector, in the case of vehicle cable sets. These monomer plasticizers demonstrate a marked tendency to migrate into the adhesives of the adhesive strips used for bundling the vehicle cable sets or cables, and to soften them. As a consequence of this, the adhesives lose their cohesion, become capable of flow, and experience an impairment of their adhesion properties.

Also taking these premises into consideration, the cross-linked rubber masses used according to the invention demonstrate clear advantages. This is because the polymer network that is present after chemical cross-linking, into which the mixed-in resins and tackifiers have partially been integrated, clearly reduces the plastification process described, so that the cables to be bundled are perfectly held together even many years later. —Natural resins and/or aromatic as well as aliphatic hydrocarbon resins can be used, as examples and without restriction.

In addition, in contrast to the UV cross-linked acrylate melt adhesives described in EP 0 937 761 B1, there is the fact that radiation chemistry cross-linking of rubber adhesive masses is significantly more reliable in terms of process. This can be attributed to the fact that any variations in the radiation energy during cross-linking have significantly less of an influence on the adhesive values achieved and the thermal stability of the rubber mass cross-linked in this manner than is the case for cross-linked acrylate melt adhesives. Furthermore, the structure of the cross-linked rubber masses, which is non-polar as compared with acrylate adhesives, also assures reliable adhesion on non-polar cable sheathings, therefore it is particularly suitable for general use.

Comparatively high adhesion values are achieved, in particular, on the vehicle cables with non-polar radiation cross-linked polyethylene sheathings and polypropylene sheathings, i.e. general polyolefin sheathings, which are increasingly in use in the automotive industry, because of this circumstance. Loosening of the adhesive strips according to the invention is not to be expected, even after many years of use. Because of this, the self-adhesive strips described are predestined for use in the bundling of cables having a soft PVC sheathing and/or a cross-linked polyolefin sheathing.

As a support for the production of the self-adhesive strip, the invention recommends recourse to a woven, non-woven, film, paper, or felt support, whereby of course, combinations of the stated materials can also function as a support material. For example, a combined woven/non-woven support is possible, as is a paper/film support. Furthermore, processing of the support at least on the side on which the rubber mass will subsequently be applied as a hot melt, i.e. polymer melt, is possible. Thus, the support strip side in question can be ground smooth or chintzed, in order to make as sealed a surface as possible available, so that the adhesive, i.e. the rubber mass, which has been converted to the low-viscosity state, cannot penetrate into the support, and the consumption of adhesive is low. Such a chintzed support and its production are described, for example, in WO 03/033 611 A1.

Furthermore, the self-adhesive strip can be structured to be flame-inhibiting, in that flame-inhibiting additives are introduced into the rubber mass and/or into the support. As a result, the use of the self-adhesive strip described for automotive applications is improved even more.

Finally, the self-adhesive strip described is characterized in that it is structured to be resistant to fogging, in total. It is known that fogging describes the condensation of volatile components from the self-adhesive strip, which result in undesirable deposits on windows, particularly the windshield, in the vehicle interior, for example. In order to preclude disadvantageous lighting conditions that result from this, the self-adhesive strip described is structured to be resistant to fogging, and structured with a fogging value of <5 mg, preferably <2 mg, measured in agreement with the VW standard PV 3015, in total.

Within the framework of this standard PV 3015, issued by VW AG, which corresponds to the DIN standard 75201 B, the self-adhesive strip described is placed into a beaker or comparable container, whereby the beaker edge is covered with an aluminum foil disk. The beaker is now placed in a heated bath at a temperature of 100±0.5° C. for a period of 16 hours±10 min.

Before that, the aluminum foil disk applied to the beaker edge is weighed. The same thing takes place after fogging of this aluminum foil disk, at the end of the test period of 16 hours±10 min, resulting in a second weight for the aluminum foil disk, which has now been fogged. In this connection, the fogging is explained by residues that leave the adhesive strip at the temperatures indicated, and should be as low as possible in order to achieve the resistance to fogging as described.

According to the invention, the difference between the two weights is less than 5 mg, preferably less than 2 mg, and consequently reproduces the amount of condensate that has deposited on the aluminum foil disk.

Other testing methods for determining the fogging value are also fundamentally possible. These are based, for example, on the “Ford Laboratory Test Method” described by the Ford company, which methods are described in detail in the U.S. Pat. No. 5,681,654 as well as EP 0 937 761 B1. In both cases, in the final analysis the light permeability of a sheet of glass and its change caused by the condensate that has deposited are determined.

1. Use of cross-linked rubber mass as a one-sided or two-sided adhesive coating on a strip-shaped support in the course of the production of a self-adhesive strip for bundling cables in motor vehicles, whereby a cross-linking agent is added to the rubber mass as a photoinitiator sensitive at wavelengths ≦400 nm.

2. Use according to claim 1, wherein a thermoplastic rubber on a styrene block copolymer basis is used as the rubber mass.

3. Use according to claim 1, wherein the rubber mass is applied to the support as a dispersion or as a hot melt, i.e. polymer melt in the low-viscosity state.

4. Use according to claim 1, wherein the rubber mass is radiation cross-linked with UV rays.

5. Use according to claim 1, wherein the support is structured as a woven, non-woven, film, paper, felt support or combination of the aforementioned materials.

6. Use according to claim 1, wherein the self-adhesive strip is structured to be resistant to fogging, with a fogging value of <5 mg, preferably <2 mg, measured in agreement with the VW standard PV 3015.

7. Use according to claim 1, wherein the self-adhesive strip is equipped to be flame-inhibiting.

8. Use according to claim 1, wherein the self-adhesive strip has a varnish coating on the side facing away from the adhesive coating.

9. Use according to claim 1, wherein the strip-shaped support is smoothly ground, i.e. chintzed, on one or both sides.

10. Use according to claim 1, wherein the self-adhesive strip is used for bundling of cables having a soft PVC sheathing and/or a cross-linked polyolefin sheathing.
